(19) United States
(12) Patent Application Publication
(10) Pub. No.: US 2010/0015419 A1
(43) Pub. Date: Jan. 21, 2010

(54) Flowing Colors Oil Painting (Waterless)

(76) Inventor: Bihua LIU, Bayside, NY (US)

Correspondence Address: LAW OFFICES OF ALBERT WAI-KIT CHAN, PLLC, 141-07 20TH AVENUE, WORLD PLAZA, SUITE 604, WHITESTONE, NY, 11357, US

(21) Appl. No.: 12/562,791

(22) Filed: Sep. 18, 2009

Related U.S. Application Data
(63) Continuation-in-part of application No. 12/405,604, filed on Mar. 17, 2009.
Application No. 12/405,604 is a continuation-in-part of application No. 10/634,526, filed on Aug. 5, 2003, now Pat. No. 7,572,126.
(60) Provisional application No. 61/160,869, filed on Mar. 17, 2009.

(51) Int. Cl. B32B 3/10; B05D 5/06

(52) U.S. Cl. 428/196; 427/256; 428/195.1; 428/211.1; 427/288

(57) ABSTRACT

This invention provides a composition of Flowing Colors oil paint formed by mixing an oil paint or oil color with a diluent. The diluent may be an oil such as linseed oil or mineral oil. The composition is suitable for “Flowing Colors” oil painting. The invention also provides methods of using the composition to prepare paintings of “Flowing Colors”. In one method, water is mixed with Flowing Colors. In another method, Flowing Colors are used without water. The invention further provides oil paintings prepared by said methods.

### CROSS-REFERENCES TO RELATED APPLICATIONS

This application claims benefit of U.S. Ser. No. 61/160,869, filed Mar. 17, 2009, and is a Continuation-in-part of U.S. Ser. No. 12/405,604, filed Mar. 17, 2009, which is a continuation-in-part of U.S. Ser. No. 10/634,526, filed Aug. 5, 2003, now U.S. Pat. No. 7,572,126, issued Aug. 11, 2009. The entire contents of the preceding applications are hereby incorporated by reference into this application.

### FIELD OF THE INVENTION

The present invention provides a composition of oil paint suitable for an innovative and unique oil painting method called Flowing Colors oil painting. The invention also provides methods of using the composition for preparing paintings of Flowing Colors. The invention further provides oil paintings prepared by said methods.

### BACKGROUND OF THE INVENTION

Flowing Colors oil painting, also called Splashing Colors oil painting, is an innovating, unique oil painting method. It is difficult to confine oil in water to construct the desired shapes. Many artists have attempted to manipulate free-flowing oil in an attempt to form precise images with the oil but have not been successful. They have managed only to make abstract paintings but not object paintings with shapes or details. The Flowing Colors oil painting method solves the problem by being capable of using oil to produce object paintings with shapes and details. The method daringly mixes two resisting elements, painting oil and water, using water to control the flow of the colorful painting oil on a wet painting medium such as paper or canvas. The oil and water mix yet repel one another, separated yet commingled together, opposed to yet supportive of each other. The subsequent effect is the ability to form accurate images with desired colorful dynamics, to express the powerful depiction of high mountains, flying clouds, rolling water, soaring tidal waves, and precise FIGURES. The marriage of water and oil, an unthinkable combination, produces images rich in color, vibrant in lights, and sophisticated in fullness and emptiness, resulting in an abstract yet classic form of painting. It is also possible to prepare Flowing Colors oil paintings of objects, shapes and images, abstract or otherwise, without the use of water, and the effects can be similar to or different from those of Flowing Colors oil paintings prepared with the use of water.

### BRIEF DESCRIPTION OF THE DRAWINGS

FIG. 1 is a perspective view of a procedure to paint special objects on a painted watercolor paper or canvas as described below. Base pan 1 is a flat surface, often rectangular, with raised edges 2. Transferring paper 3 is either watercolor paper or canvas that is used to mix and transfer Flowing Colors. Masking paper 4 is either watercolor paper or canvas wherein the shape of an object 5 (a star in the instant example) is cut out from the paper or canvas. Item 6 refers to water color paper or canvas that has been painted, with the painted side facing down.

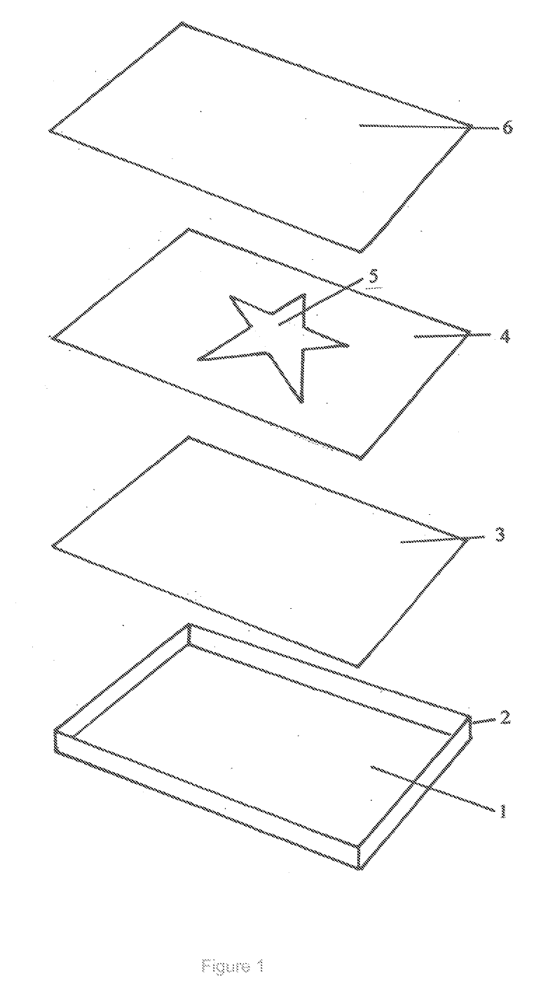

### DETAILED DESCRIPTION OF THE INVENTION

### Definitions

Unless otherwise stated, the following terms used in the specification and claims have the meanings given below:

The term “Flowing Colors” refers to oil paints or oil colors that have been formulated with a diluent, and are therefore suitable for “Flowing Colors” oil painting. “Flowing Colors” may be stored in a large container, or a squeezable plastic bottle with a pointed spout for future use.

“Oil” as an ingredient of a diluent refers to any of numerous mineral, vegetable and synthetic oils, or animal and vegetable fats that are generally soluble in various organic solvents such as ether but not in water. Preferably, the oil is mineral oil or baby oil.

“Base pan” refers to a flat surface, often rectangular, with raised edges around entire perimeter. Examples of base pan include, but are not limited to, trays, pans, dishes and low edged containers. Preferably, the base pan is a framed canvas. One skilled in the art would prepare a framed canvas by stretching a canvas over a rectangular frame and securing the canvas on the frame. This framed canvas, when used with the frame facing upwards, serves to catch and hold any dripping oil during the process of Flowing Colors oil painting.

“Painting medium” refers to any medium to which the method of “Flowing Colors” oil painting may be applied to produce “Flowing Colors” paintings, such as, but not limited to, a piece of paper, wood, glass or cloth. A preferred painting medium is watercolor paper or canvas. Accordingly, a “painted medium” is any of the above-mentioned medium that has been painted and dried.

“Watercolor paper” has its ordinary meaning known to one skilled in the art. The “watercolor paper” can be purchased in any art store. Preferably, the watercolor paper is thick enough to absorb water easily without tearing. Also, its surface is preferably neither too rough nor too smooth.

“Canvas” has its ordinary meaning known to one skilled in the art. Canvas can be purchased in any art store. Preferably, the canvas has no coating on either side and is made with water-absorbing material.

“Transferring paper” refers to watercolor paper or canvas that is used to mix, absorb and transfer Flowing Colors.

“Masking paper” refers to watercolor paper or canvas from which the shape of an object or FIGURE is to be cut out. For example, a masking paper having a hollow star may be prepared by drawing and then cutting out a star on a watercolor paper or canvas. Preferably, the masking paper is watercolor paper as defined above.

“Painted canvas” or “painted watercolor paper” refers to canvas or watercolor paper, respectively, that has been painted and dried.

### Tools and Materials

1. Flowing Colors as defined above.
2. A flat, sturdy surface, or a base pan as defined above.
3. A painting medium, preferably a canvas or watercolor paper, or as defined above.
4. A device to move Flowing Colors. An example of such a device is a palette knife, painting brush, hair brush or a hair dryer. The device is to sweep, brush or blow Flowing Colors in various directions to form desired shapes.
5. A device to apply water or oil colors onto a painting medium. Examples of such a device include, but are not limited to, a spray bottle, a squeeze bottle with a pointed spout, and any container.
6. Tapes, rollers and paper towels.

### Method to Prepare a Flowing Colors Oil Painting

The essential technique of Flowing Colors oil painting of the present invention is to direct and control Flowing Colors so that they move on a wetted painting medium in ways and directions premeditated according to a painter's design. A method to prepare an oil painting by using the present invention is illustrated by the following steps using canvas as an example of a painting medium. This method is for illustrative purpose only, and is not meant to limit the scope of the invention:
1) Place a blank canvas over a base pan.
2) Optionally secure each edge of the canvas to the base pan with tapes.
3) Optionally spray water onto the canvas with a spray bottle, and gently brush off any creases from the canvas with a big brush until the blank canvas is completely smooth and flat.
4) Spray water on the canvas to form a thin layer of water (the base pan will catch any dripping water).
5) Apply one or more Flowing Colors to one or multiple parts of the wetted canvas.
6) Direct the Flowing Colors to flow in different directions, allowing them to mix with each other if so desired, in order to form a desired shape or image; this can be done by moving the base pan in various ways, or by brushing the Flowing Colors with a brush, or by blowing the Flowing Colors in different directions with a hair dryer. (For example, moving the base pan left and right allows the Flowing Colors to form rivers, up and down to form mountains, circularly to form an eddy, and diagonally to form clouds.)
7) Dry the Flowing Colors with a drying device such as a hair dryer to stop the Flowing Colors from flowing further and to make them stay in the desired locations, whereby completing a colorful painted canvas.
8) Optionally, an artist may wish to add special objects, images or FIGURES on the painted canvas by using traditional painting methods known to one skilled in the art. The special objects, image or FIGURES can also be painted on the painted canvas by using the Flowing Colors method of the present invention.

### Method to Paint Objects on a Painted Medium

Certain objects such as vases, animals, humans, and etc. can be added to a painted medium by using Flowing Colors. The example below illustrates a method using canvas as the painting medium; this method is for illustrative purpose only, and is not meant to limit the scope of the invention:
1) Prepare a painted canvas according to the method described above, and remove it from the base pan.
2) Prepare a masking paper wherein the shapes of one or more objects have been drawn and cut out. The masking paper and the painted canvas are preferably of the same size.
3) Place a blank transferring paper over the base pan.
4) Optionally, secure each edge of the transferring paper to the base pan with tapes.
5) Optionally, spray water onto the transferring paper with a spray bottle, and gently brush off any creases from the canvas with a big brush until the transferring paper is completely smooth and flat.
6) Spray water onto the transferring paper to form a thin layer of water (the base pan will catch any dripping water).
7) Apply one or more Flowing Colors to those parts of the wetted transferring paper corresponding to the cut-out parts on the masking paper, and direct the Flowing Colors to flow freely and mix with each other.
8) Before the Flowing Colors on the transferring paper dry up, place the masking paper on top of the transferring paper, and place the painted canvas on top of the masking paper with the painted side facing the transferring paper.
9) Roll the back of the painted canvas gently with a roller to allow the Flowing Colors on the transferring paper to be transferred to the painted side of the painted canvas through the hollow space of the masking paper, resulting in the desired object, image or FIGURE being added to the painted canvas.
10) Remove the painted canvas from the masking paper, and let the canvas dry.
11) Repeat the procedure to add more objects, images or FIGURES to the painted canvas if desired.

Alternatively, the desired objects, images or FIGURES can be added to a painted medium such as canvas by the following process, which is for illustrative purpose only and is not meant to limit the scope of the invention:
1) Prepare a painted canvas;
2) Place the painted canvas over a base pan with the painted side facing up;
3) Prepare a masking paper with the desired shapes cut out, and place the masking paper on top of the painted canvas;
4) Moisturize the surface of the masking paper evenly;
5) Apply Flowing Colors near the edges of the cut-out shapes, and brush the Flowing Colors over the painted canvas;
6) Remove the masking paper, and let the Flowing Colors on the painted canvas dry up.

### Examples of Painting Specific Objects

The following examples, with canvas as the painting medium, are for illustrative purpose only and are not meant to limit the scope of the invention.

### Cloud Painting

Wet a blank canvas over a base pan with a sprayer. Splash Flowing Colors, such as red, purple, white, yellow and blue on the wetted canvas. Move the base pan circularly to let the colors mix naturally like clouds. Blow the mixing Flowing Colors gently to form dispersing clouds.

### Running Water Painting

Wet a blank canvas over a base pan as described above. Splash Flowing Colors such as blue or green on the canvas to allow the Flowing Colors to flow freely. Add some complementary colors such as light red, light purple or yellow. Move the base pan left and right to create an image of calm water. Move the base pan diagonally to create an image of a stream. Move the base pan circularly to create an image of high waves and deep eddy. When the Flowing Colors become dry, one can add reflections and inverted images, or add light and dark colors to express shadows by using the traditional oil painting methods to achieve three-dimensional effects. Optionally, one may add objects such as see weeds, leaves, dropped flowers, lotuses, maples, and etc. with Flowing Colors oil painting method or traditional painting methods.

### Vase Painting

Prepare a painted canvas according to the method of the present invention, or by using traditional painting methods. Prepare a masking paper with the shapes of one or more vases cut out. Place the painted canvas over a base pan with the painted side facing up. Place the masking paper on top of the painted canvas. Wet the masking paper and brush the water evenly. Add Flowing Colors near the outlines of the vases. Move the base pan circularly to allow the Flowing Colors to flow naturally to cover the vase shapes. After the Flowing Colors have dried, remove the masking paper, and add light and dark colors to simulate shadows in order to achieve a three-dimensional effect.

### Flower Painting

On a wetted blank canvas over a base pan, apply Flowing Colors by using a squeezable bottle with a pointed spout. Preferably, one may apply similar colors and neighboring colors over several layers. Blow dry and firm each layer separately with a hair dryer to form petals of a flower. The overflowed Colors can be cleaned away by a wet towel. The same technique can be used to paint leaves. The color of the leaves should vary. After the Flowing Colors dry up, one can add light and dark colors to simulate shadows, and add detailed structures on the flowers and leaves.

### Human Body Painting

Prepare a transferring paper by applying Flowing Colors to a blank canvas over a base pan. Preferably, the Flowing Colors are applied using a squeezable bottle with a pointed spout. Move the base pan so that the Flowing Colors flow and mix freely. Wait to let the Flowing Colors partially dry. Prepare a painted canvas. Prepare a masking paper with the shape of a human body cut out. Attach the masking paper to the painted side of the painted canvas and tape the two together. place them over the transferring paper with the painted side of the painted canvas facing the transferring paper. Using a painting roller, roll the back of the painted canvas to allow the Flowing Colors to transfer from the transferring paper to the painted canvas through the hollow space on the masking paper. Remove the taped masking paper and painted canvas from the transferring paper, and separate the painted canvas from the masking paper. After the Flowing Colors on the painted canvas dry up, add light and dark colors to simulate shadows around the human body image to achieve a three-dimensional effect.

Flowing Colors oil paintings can also be prepared without the use of water. The following example is for illustrative purpose only, and is not meant to limit the scope of the invention:
1) Place a blank canvas over a flat, sturdy surface;
2) Optionally draw on the canvas outlines of objects or shapes to be painted;
3) Apply one or more Flowing Colors to one or multiple parts of the canvas, and/or within the outlines from step 2;
4) Direct the Flowing Colors to flow in different directions, allowing them to mix with each other if so desired, in order to form a desired shape or image; this can be done by sweeping the Flowing Colors with a palette knife, brushing the Flowing Colors with a brush, or blowing the Flowing Colors in different directions with a hair dryer;
5) Dry the Flowing Colors with a drying device such as a hair dryer to stop the Flowing Colors from flowing further and to make them stay in the desired locations;
6) Repeat steps 3 to 5 as needed;
7) Optionally, an artist may wish to add special objects, images or FIGURES, or enhance the effects of color contrast or three-dimension, on the painted canvas by using traditional painting methods known to one skilled in the art. The special objects, image or FIGURES can also be painted on the painted canvas by using the Flowing Colors method of the present invention.

### Composition of Paint

The present invention also provides a composition suitable for use as “Flowing Colors”. The technique of “Flowing Colors” oil painting requires the use of an oil paint or oil color that is fluid enough to flow or be splashed. Oil paints currently on the market do not have the proper viscosity or mobility suitable to be Flowing Colors. The present composition comprises an oil paint or oil color mixed with a proper amount of a diluent to achieve the desired viscosity.

A diluent as used herein is any oil-miscible liquid that, when mixed with an oil paint or oil color, is suitable for use as “Flowing Colors”. The diluent may be chosen based on its physicochemical properties that may affect the “drying” time, reflectivity, color effect or viscosity. An oil paint or oil color typically contains a drying oil such as linseed oil which polymerizes upon standing, in effect “drying” the oil.

Any commercially available or newly formulated oil paint or oil color may be used in the present composition. An oil paint is any paint that is miscible with oil but not water, and may be used for oil painting or household painting. An oil color is one that is typically used for oil painting. Alternatively, during the manufacture of an oil paint or oil color, a proper amount of a diluent can be added to produce the present composition suitable for use as “Flowing Colors” without the need to do any mixing prior to painting. The composition can be of any colors, transparent or translucent.

In one embodiment of the present invention, a composition is formed by mixing an oil paint or oil color with a diluent in a ratio of about 95:5 to about 20:80, preferably in a ratio of about 50:50 to about 30:70.

The diluent may be one or more oils selected from, but is not limited to, walnut oil, poppy seed oil, tung oil, perilla oil, hempseed oil, pine nut oil, sunflower oil, castor oil, safflower oil, soybean oil, mineral oil, linseed oil, vegetable oil, synthetic oil and baby oil.

In one embodiment of the present invention, the oil paint is enamel. In another embodiment, the diluent is linseed oil or baby oil. In yet another embodiment, the composition is colored or colorless.

The present invention also provides a method of using the above composition for Flowing Colors oil painting, comprising the steps of:
a) Securing a painting medium over a base pan;
b) Moisturizing said painting medium with a film of water;
c) Depositing and moving one or more of the present composition on said painting medium to produce a first image;
d) Removing said painting medium from the base pan and securing a transferring paper over the base pan;
e) Moisturizing said transferring paper with a film of water;
f) Depositing and moving one or more of the present composition on said transferring paper to produce a second image;
g) Placing onto said transferring paper a masking paper with a hollow shape over said second image;
h) Placing said painting medium over masking paper with the first image facing said second image, and transferring said second image onto said painting medium;
i) Separating said painting medium and allowing it to dry.

Another method of using the above composition for Flowing Colors oil painting comprises the steps of:
a) Placing a painting medium over a flat, sturdy surface;
b) Optionally drawing on the painting medium outlines of objects or shapes to be painted;
c) Applying one or more Flowing Colors to one or multiple parts of the painting medium, and/or within the outlines from step b;
d) Directing the Flowing Colors to flow and mix wherein desired shapes and images are formed;
e) Drying the Flowing Colors with a drying device; and
f) Repeating steps c to e as needed.

In one embodiment of the methods, the diluent in the composition is walnut, poppy seed, tung, perilla, hempseed, pine nut, sunflower, castor, safflower, soybean, mineral, linseed, vegetable, synthetic or baby oil, or a combination thereof.

In another embodiment of the methods, the composition is formed by mixing an oil paint or oil color with a diluent in a ratio of about 50:50 to about 30:70. In yet another embodiment of the method, the diluent in the composition is linseed oil or baby oil.

In one embodiment of the methods, the composition is colored or colorless. In another embodiment of the methods, the oil paint in the composition is enamel. In a further embodiment of the methods, the painting medium is watercolor paper or canvas.

The present invention further provides oil paintings prepared by the above methods.

What is claimed is:

1. A method of preparing an oil painting using a composition formed by mixing an oil paint or oil color with a diluent in a ratio of about 75:25 to about 25:75, comprising the steps of:
a) Placing a painting medium over a flat, sturdy surface;
b) Optionally draw on the painting medium outlines of objects or images to be painted;
c) Applying one or more said composition to one or multiple parts of the painting medium;
d) Directing the Flowing Colors to flow and mix wherein desired shapes and images are formed;
e) Drying the Flowing Colors with a drying device; and
f) Repeating steps c to e as needed.

2. The method of claim 1 wherein the diluent in the composition is walnut oil, poppy seed oil, tung oil, perilla oil, hempseed oil, pine nut oil, sunflower oil, castor oil, safflower oil, soybean oil, mineral oil, linseed oil, vegetable oil, synthetic oil, baby oil, or a combination thereof.

3. The method of claim 1 wherein the composition is formed by mixing an oil paint or oil color with a diluent in a ratio of about 50:50 to about 30:70.

4. The method of claim 1 wherein the diluent in the composition is linseed oil or baby oil.

5. The method of claim 1 wherein the composition is colored or colorless.

6. The method of claim 1 wherein the oil paint in the composition is enamel.

7. The method of claim 1 wherein the painting medium is watercolor paper or canvas.

8. An oil painting prepared by the method of claim 1.

9. An oil painting prepared by the method of claim 2.

10. An oil painting prepared by the method of claim 3.

11. An oil painting prepared by the method of claim 4.

12. An oil painting prepared by the method of claim 5.

13. An oil painting prepared by the method of claim 6.

14. An oil painting prepared by the method of claim 7.
